(19) United States
(12) Patent Application Publication
(10) Pub. No.: US 2006/0120611 A1
(43) Pub. Date: Jun. 8, 2006

(54) Apparatus and method for transmitting an advanced image

(75) Inventor: Seong-Gu Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/292,108

(22) Filed: Dec. 2, 2005

(30) Foreign Application Priority Data
Dec. 2, 2004 (KR) 2004-0100673

(51) Int. Cl. G06K 9/36

(52) U.S. Cl. 382/232

(57) ABSTRACT

An apparatus and method for transmitting an advanced image are provided. The apparatus includes: an encoder for encoding image data according to a frequency component of the image data; a fragmenter for selecting a part of the encoded image data based on a fragmentation position calculated using PSNR value; and a transmitter for transmitting the selected image data and information on a size of the encoded image.

### CROSS-REFERENCE TO RELATED PATENT APPLICATION

This application claims the benefit under 35 U.S.C. §119(a) of Korean Patent Application No. 2004-0100673, filed Dec. 2, 2004, in the Korean Intellectual Property Office, the entire disclosure of which is hereby incorporated by reference.

### BACKGROUND OF THE INVENTION

1. Field of the Invention

The present invention relates to an apparatus and method for transmitting an advanced image. More particularly, the present invention relates to an apparatus and method for transmitting to a subscriber an advanced image, such as (Joint Photographers Experts Group 2000 (JPEG2000) or Set Partitioning In Hierarchical Trees (SPIHT)), having a desired quality and making efficient use of network resources when transmitting the advanced image over a communication network.

2. Description of the Related Art

JPEG2000 is the next generation still image standard. It integrates various additional functions into the existing JPEG still image standard. JPEG2000 provides a higher compression ratio and better quality compared with any other standard encoding technology. The high compression and quality are due to the application of a wavelet transform. A wavelet transform is a mathematical formula for analyzing an image and for compressing the image so that it takes significantly less data to represent the image. Applications using JPEG2000 support compression that is not supported by other similar applications.

The use of a wavelet transform for image compression reduces the occurrence of blocking artifacts that distort the image. Image compression using a wavelet transform is carried out by using a wavelet transform on an original image and then efficiently quantizing the image's wavelet coefficient. In other words, JPEG2000 overcomes blocking artifacts that would otherwise occur with JPEG, by using a wavelet transform-based compression method. Further, use of a wavelet transform makes it possible to utilize a progressive transmission method when communicating images.

JPEG2000 has excellent performance at a low bit rate when compressing color still images, and therefore it can be applied to document synthesis, computer images, facsimile and other types of images by means of a continuous-tone and bi-level compression. Further, JPEG2000 can prevent and correct errors, and is robust enough to handle bit errors resulting from coding a source-channel into a wireless communication channel.

A wavelet transform is a known mathematical function but it has only recently been used for digital signal processing and image compression. The wavelet transform was first developed in the late 20th century and its basic principle is similar to that of a Fourier transform. When used for signal processing, the wavelet allows for the restoration of weak signals having a relatively high level of noise. The availableness of the wavelet for use in signal processing was established by its use in the medical field for X-ray and magnetic resonance image processing. Images processed in this manner are clear and do not blur details.

Wavelet transforms are also used for image compression in Internet communications. In general, the wavelet has much higher performance compared with any other means of compression. For example, an image compressed using a wavelet could have a file size that is only 25% of the file size of a similar quality image using conventional JPEG based compression. Wavelet compression is performed by analyzing an image, and then transforming the analyzed image into mathematical expressions capable of being restored on a receiver side. These wavelet-compressed image files have a computer file extension of “WIF.” If a user's browser does not directly support these file formats, a plug-in program would be required to display a “WIF” image. Wavelet-based compression methods include SPIHT in addition to JPEG2000.

FIG. 1 is a block diagram of an encoder and a decoder based on JPEG2000. The encoder 110 serves to transform an original image file into a JPEG2000 format. The encoder 110 first divides an input image into tiles that are rectangular fragments which do not overlap, and then performs a color transformation on the components of each pixel. Here, there are two color-transformation methods used, one is an irreversible color transformation which transforms an RGB input image into YCbCr and the other is a reversible color transformation. The difference between YCbCr and RGB is that YCbCr represents color as brightness and two color difference signals, while RGB represents color as red, green and blue. In YCbCr, the Y is the brightness (luma), Cb is blue minus luma (B−Y) and Cr is red minus luma (R−Y).

After the color transformation, the encoder 110 performs a DWT (Discrete Wavelet Transform) on an entire frame. Because a DWT transforms an entire image it does not cause the blocking artifacts that are typically generated with a large image or when using a high compression ratio. Further, by using an integer DWT filter, it is possible to perform lossy and lossless compression with the same compression bit stream. After the DWT, the frame is subjected to quantization and entropy coding, and then transmitted to a receiving terminal.

The frame is transformed into data using the wavelet, and then the transformed data undergoes quantization. The quantized data is subjected to entropy coding. The decoder 120 located at the receiving terminal performs the operation of encoder 110 of the transmission terminal in reverse. When the encoded image data is received, it is subjected to entropy decoding, inverse quantization and then an inverse wavelet transform.

FIG. 2 shows a DWT method based on JPEG2000. FIG. 2 shows the DWT method, which is described with reference to FIG. 1, in more detail. The wavelet transform is performed on an original image. The wavelet transform used in JPEG2000 causes high-pass and low-pass filters to act on the length and width of the image at the same time. Therefore, as a result of the wavelet transform, the image is divided into four sub-bands, LL, HL, LH and HH sub-bands, of which the LL sub-band has a low frequency component in both x and y directions, the HL and LH sub-bands have a low frequency component in any one of both x and y directions and a high frequency component in the other direction, and the HH sub-band has a high frequency component in both x and y directions. Further, after the filtering, down sampling is performed in the x and y directions. Thus, as shown in FIG. 2, the four sub-bands HH, HL, LH and LL shown schematically are created from the original image. The LL sub-band of the four sub-bands has the lowest frequency component among the frequencies constructing the image, the HH sub-band has the highest frequency component, and the LL sub-band has more significant data of the image than those of the HL, LH and HH sub-bands. The original image shown in FIG. 2 may be decomposed with higher precision. Subsequently, the low-pass component, the LL sub-band of FIG. 2, is decomposed. The decomposition is called an octave decomposition scheme.

The existing communication network as set forth above employs a scheme of constructing and transmitting an entire image at once, which means that an enormous quantity of data is transmitted through the network in order to communicate the image. In other words, when an image file having a file size of 500 Kbytes is transmitted, it is not until all 500 Kbytes are transmitted that the image is decoded and recognized at the reception terminal. An error occurs during the decoding if not all of the 500 Kbytes have been received. This file transmission method generates a lot of traffic on the network because it requires that the entire large file be transmitted before being displayed.

Accordingly, there is a need for an improved method and apparatus for sending an advanced image without having to send the entire image so as to reduce network traffic.

### SUMMARY OF THE INVENTION

An aspect of the present invention is to address at least the above problems and/or disadvantages and to provide at least the advantages described below. Accordingly, an aspect of the present invention is to provide an apparatus and method for transmitting an advanced image via a network, in which the advanced image is compressed in an advanced format for being transmitted. Thereby, sufficient image quality is maintained while providing increased network efficiency.

According to an aspect of the present invention, there is provided an image transmitting apparatus including: an encoder for encoding image data by decomposing the image data according to a frequency component of the image date; a fragmenter for selecting a part of the encoded image data based on a fragmentation position calculated using PSNR value; and a transmitter for transmitting the selected part of the image data and information on a size of the encoded image. The image data may be encoded by use of wavelet transform. The wavelet transform may be performed using at least one of JPEG2000 (Joint Photographers Experts Group 2000) and SPIHT (Set Partitioning In Hierarchical Trees).

The fragmenter may receive the image data intended for transmission and information on desired image quality from the user, determine a value of PSNR (Peak Signal to Noise Ratio) corresponding to the received desired image quality information, compare the PSNR value with a fragment reference value preset to act as a standard for permitting fragmentation, calculate a position of a fragmentation position according to the PSNR value from the encoded image data when the PSNR value exceeds the fragment reference value, and fragment the encoded image data on the basis of the calculated fragmentation position.

The fragment reference value may be set within a range such that when image restoration is performed at the reception terminal a restored image is visually similar to the original image. The fragment reference value may be set to 30 dB.

According to another aspect of the present invention, there is provided an apparatus for receiving an image including: a receiver for receiving fragmented image data and information on an image size from a transmission terminal; a defragmenter for adding NULL data to the received fragmented image data and then generating new image data having a size identical to the received image size; and a decoder for decoding the new image data generated by the defragmenter. The decoding may be performed by use of wavelet inverse transform. The wavelet inverse transform may be performed using at least one of JPEG2000 (Joint Photographers Experts Group 2000) and SPIHT (Set Partitioning In Hierarchical Trees).

According to yet another aspect of the present invention, there is provided a method for transmitting an image including the steps of: encoding image data by decomposing the image data according to a frequency component of the image data; selecting a part of the encoded image data based on a fragmentation position calculated using PSNR value and fragmenting the encoded image data according to the selected part of the encoded image data; and transmitting the selected image data and information on an entire size of the encoded image.

According to still another aspect of the present invention, there is provided a method for receiving fragmented image including the steps of: receiving image data and information on an image size from a transmission terminal; adding NULL data to the received fragmented image data and then generating new image data having a size identical to the received image size; and decoding the generated new image data.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a block diagram of an exemplary JPEG2000 encoder and a decoder;

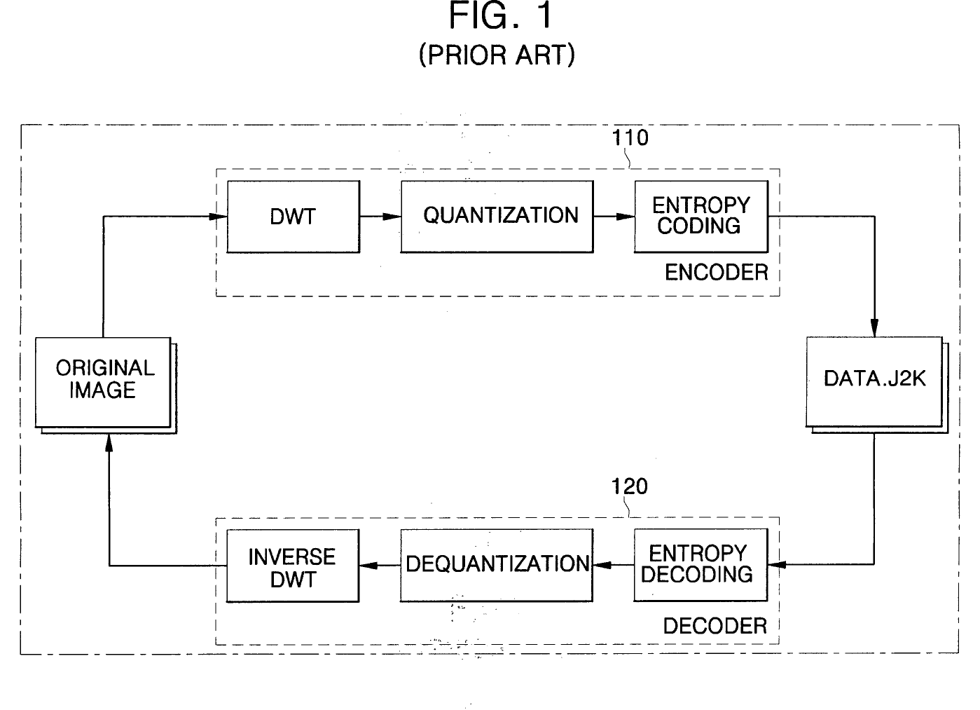

FIG. 2 shows a JPEG2000 based DWT method;

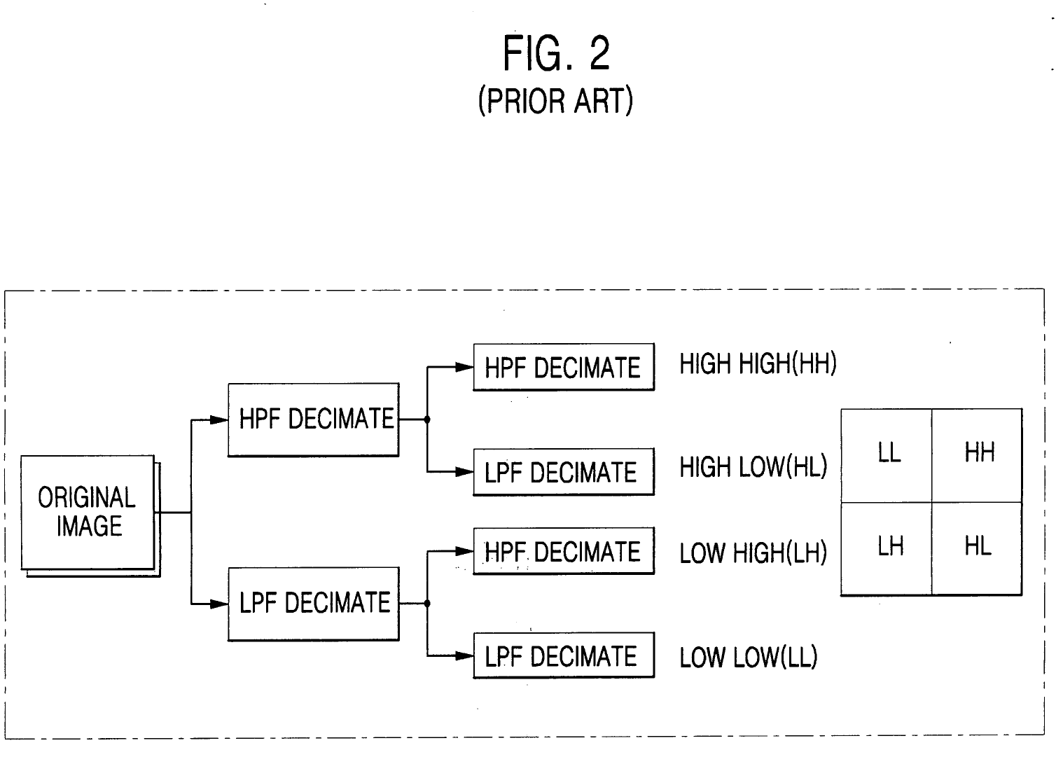

FIG. 3 shows an exemplary image transmitting apparatus according to an embodiment of the present invention;

FIG. 4 shows the structure of the fragmented data at various Peak Signal to Noise Ratios created by an image transmitting apparatus according to an embodiment of the present invention;

FIG. 5 illustrates a flow chart for processing an image at a transmission terminal of an image transmitting apparatus according to an embodiment of the present invention; and

FIG. 6 illustrates a flow chart for processing an image at a reception terminal of an image transmitting apparatus according to an embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

An embodiment of the present invention is adapted to allow a user to select a desired image quality for an advanced image to be transmitted based on characteristics of the image and to transmit the image in the corresponding transmission method. When a transmission method according to the above embodiment of the present invention is selected, a file size of the transmitted image can be reduced. The reduction in file size results in reduced network traffic for an entire network. This increased efficiency in the network will generally allow the price of service to be lowered.

The advanced image (JPEG2000 or SPIHT) is compressed using a wavelet transform. With an advanced image, important information is allocated at the beginning of the image data, and less important information is allocated at the end of the image data. When an error occurs in the image date of an advanced image, the image can be restored due to its excellent error correction by using only the important information.

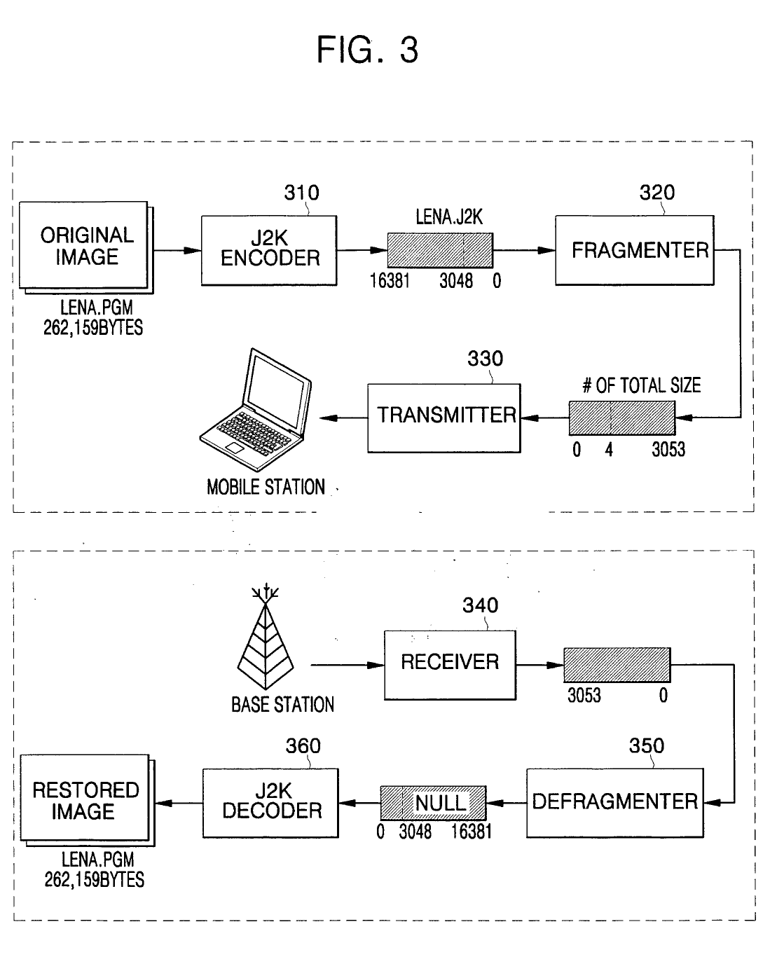

FIG. 3 shows an exemplary image transmitting apparatus according to an embodiment of the present invention. The embodiment of FIG. 3 is directed to a mobile communication system in which a subscriber accesses a base station via radio using a terminal, such as a mobile phone, to perform communication.

After accessing a data network, the subscriber requests to transmit image data with his/her desired value of PSNR (Peak Signal to Noise Ratio in dB) to the base station. In the embodiments of the present invention, the PSNR is used as a measure of evaluating the quality of an image.

The PSNR is given as the following Equation 1.

$$Equation 1 \text{:}$$

$$PSNR = 20 ⋆ {log}_{10} ( \frac{255}{RMSE} ) RMSE = \sqrt{\frac{\sum {( {f}_{ij} - {F}_{ij} )}^{2}}{{N}^{2}}}$$

where fᵢⱼ=a pixel of the original image, and Fᵢⱼ=a pixel of the reconstructed image. The image represented by Equation 1 has a size of N×N, and the term RMSE refers to a root mean squared error.

A JPEG2000 image is made by encoding the original uncompressed image using a J2K encoder 310. In the embodiment of FIG. 3, it can be seen that the original image has a file name of “lena.pgm”, and a size of 262,159 bytes.

The PSNR value requested by the subscriber is calculated with JPEG2000 image data, and then a position for fragmenting the data is determined. This fragmentation is performed by fragmenter 320. A transmitter 330, receiving the fragmented image data fragmented by the fragmenter 320, transmits only a first part of the data. The first part of the data is the data preceding a fragmentation position set by fragmenter 320. The fragmented image data includes information on the size of the original JPEG2000 file and the information is located ahead of the first part of the data in the fragmented image data. The original JPEG2000 size information is included because decoder 360 of the reception terminal can not perform decoding without information on the entire file size. The transmitter 330 transmits the fragmented image data.

When receiving the fragmented image data transmitted from the transmission terminal at the receiver 340 of the reception terminal, a defragmenter 350 constructs a file the same size as the size of the original JPEG2000 file. It does so using the original JPEG2000 file size information located at the beginning of the data received from the transmission terminal. It can be seen from FIG. 3 that the original JPEG2000 file size information takes up four bytes.

The original JPEG2000 file is divided into a first part, data which precedes the fragmentation position and is received by the reception terminal, and a second part, data which follows the fragmentation position and is not actually transmitted. Since the second part of the original JPEG2000 file is not received, it is processed as NULL data to obtain the original image file size.

In the aforementioned manner, the defragmented file size is equal to the original JPEG2000 file size prior to fragmentation, with the first part being the same as in the original JPEG2000 file, and the second part being filled with NULL data. The JPEG2000 data is restored to the same size as the original image through the J2K decoder 360. The restored image is an image substantially identical to the original image, but having less image information than the original image. Thus, the restored image has lower quality than the original but is of sufficient quality to be recognized. In addition, the restored data reduces the load applied to the network.

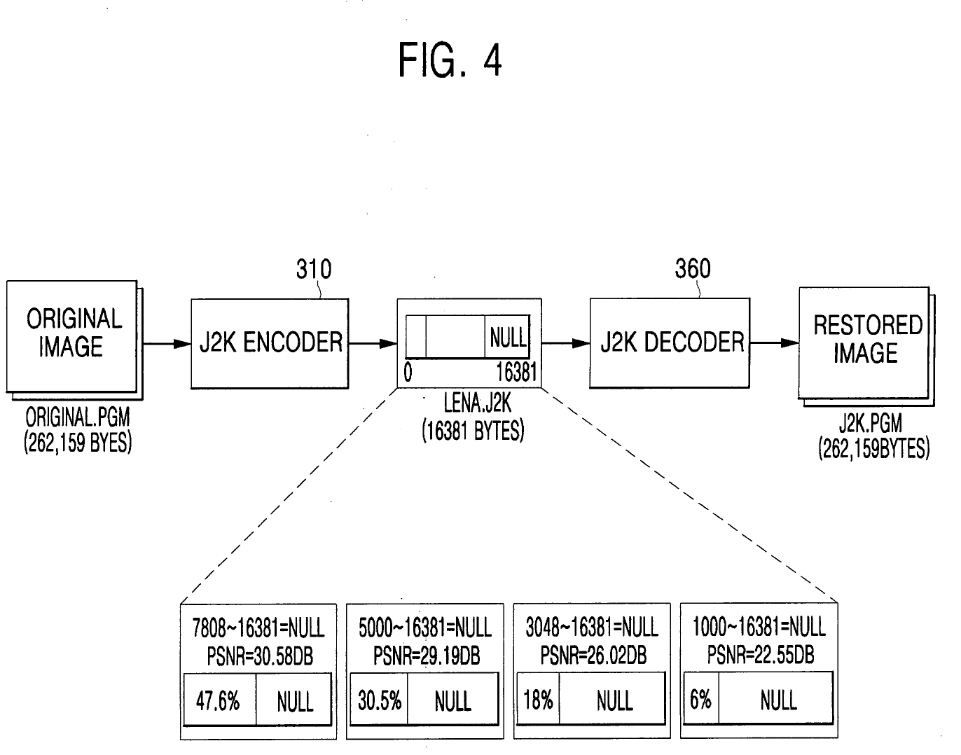

FIG. 4 shows the structure of the fragmented data at various PSNRs created by an image transmitting apparatus according to an embodiment of the present invention.

An image file encoded by J2K encoder 310 of an image transmitting apparatus according to an embodiment of the present invention has a size different than the size of an original image file. As such, the encoded image file is adjusted in size so as to be restored to its original size prior to being decoded at a J2K decoder 360.

Since data after a fragmentation position has been already cut off at the transmission terminal, the part that is cut off from the original image is filled with NULL data. Further, because the important part of the original image is located before the fragmentation position there is no difficulty in recognizing the original image despite the data after the fragmentation position being filled with NULL data.

By way of example in FIG. 4, various fragment reference values are shown, and that that for each the data part after the fragmentation position is completely filled with NULL data. On the basis of the data amounting to 16,381 bytes, PSNR 30.58 dB is set to the fragment reference value for the first data, PSNR 29.29 dB for the second data, PSNR 26.02 dB for the third data, and PSNR 22.55 dB for the fourth data. The lesser the PSNR value, the greater the weight which the NULL data is given.

As a result of encoding and decoding the image, while varying the PSNR value as in FIG. 4, it is determined whether or not an image similar to the original image can be restored on the basis of the PSNR value being 30 dB. In other words, it is preferred for the PSNR value to be about 30 dB as that PSNR value is capable of reducing a load applied to the network without having a great influence on the quality of image. When the PSNR value is more than 50 dB, it is identical to the original image. It is easy to recognize the corresponding image when the PSNR value exceeds 30 dB.

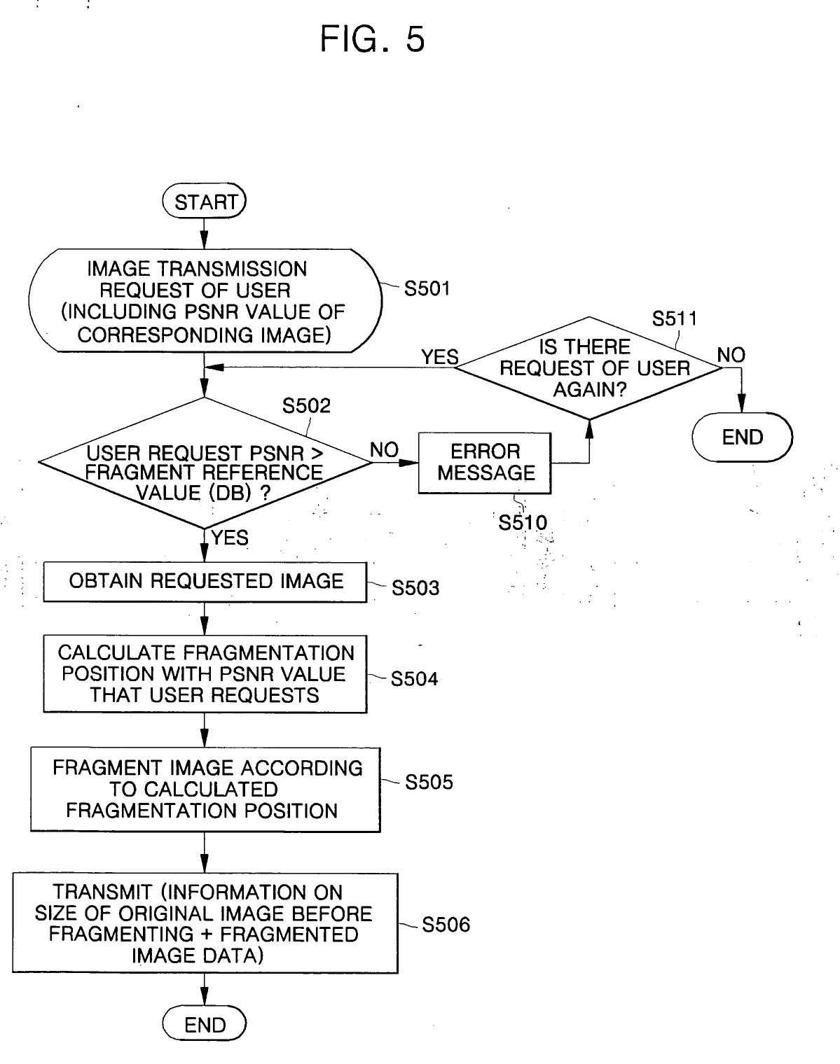

FIG. 5 illustrates a flow chart for processing an image at a transmission terminal of an image transmitting apparatus according to an embodiment of the present invention.

An image transmission request is made by a user who performs communication through a mobile communication network, the Internet, or any other communications medium.

A user requests not only to transmit a specified image but also indicates a PSNR value that he/she wants to transmit the image in (S501). In the embodiment of FIG. 5, this step may be realized by having the user input the PSNR value prior to requesting the transmission of the image. However, if a user requests transmission of the image without inputting a PSNR value, a message can be displayed prompting the user to input a PSNR value.

Further, it is possible to make setting a PSNR value more user friendly by using terms familiar to the user by using the expressions “high definition/normal/saving” instead of a technical term such as PSNR. In this case the apparatus may designate and send a PSNR value that corresponds to the expression.

The apparatus receiving the image transmission request of the user compares the PSNR value that the user inputs with a fragment reference value (S502). The fragment reference value is set to a PSNR value sufficient to obtain a satisfactory result when the corresponding image is restored. As described above with reference to FIG. 4, it is preferable to use a PSNR value of about 30 dB as that has been shown to produce a satisfactory image to the human eye. This value may be set or varied by a manager of the apparatus. Thus, it is preferable for the manager to set the fragment reference value to 30 dB or more when a higher definition image is required, or to set the fragment reference value to 30 dB or less in the apparatus when it is desired to increase the efficiency of the network.

If the PSNR value requested by the user does not reach the fragment reference value, an error message is output (S510) informing the user that the restored image with the PSNR value requested by the user may not have sufficient quality. If the user requests to transmit the corresponding image again (S511), the step of comparing the PSNR value with the fragment reference value is again performed (S502).

When the PSNR value requested by the user exceeds the fragment reference value, the apparatus obtains the image to be transmitted (S503) and starts preparing the corresponding image for transmission. It is preferred that the apparatus store the corresponding image in an image supply server rather than a database. Therefore, the apparatus according to a preferred embodiment of the present invention accesses the server in which the corresponding image is stored, through the Internet, to obtain the corresponding image.

The apparatus obtaining the corresponding image detects the file size of the corresponding image, and calculates a fragmentation position for the file image size according to the PSNR value requested by the user (S504). When the fragmentation position is calculated, the corresponding image is fragmented on the basis of the fragmentation position (S505).

The first part of the fragmented image is an important part of the image file, and thus is transmitted intact. However, the second part of the image, after the fragmentation position, is not transmitted. At this point information on a value of the file size of the original image before fragmenting is transmitted together with the second part (S506). This value is required to restore the image file to an original data size when restoring the image data at the reception terminal.

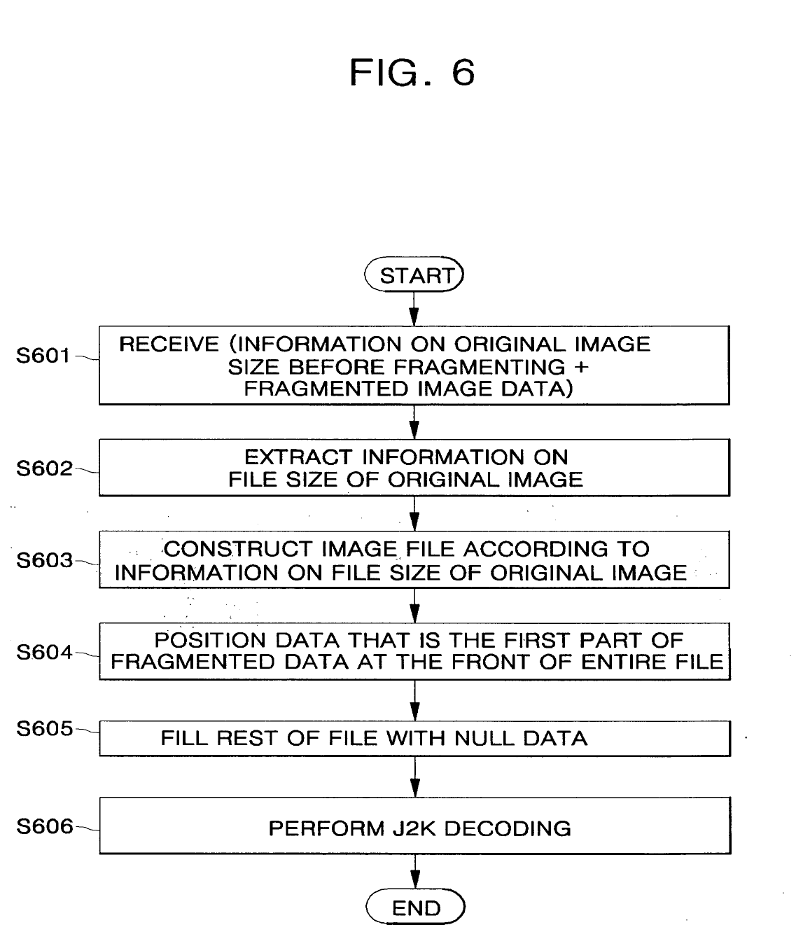

FIG. 6 illustrates a flow chart for processing an image at a reception terminal of an image transmitting apparatus according to an embodiment of the present invention.

A file including a size value of an original image before fragmenting and an image of the first part of fragment data is received from a transmission terminal through a wired and/or wireless transmission path at the reception terminal of an image transmitting apparatus (S601). At the reception terminal, information on a file size of the original image is extracted from the received file (S602). The file size information is located at the first part of the received fragment data. At the reception terminal, a file is constructed as large as the size of the original JPEG2000 file in the transmission terminal according to the file size of the extracted original image (S603). When the file is constructed, the beginning of the file is allocated with the received image data of the first part (S604). The rest of the file is filled with NULL data (S605). When the image of the original file size is completed in this way, JPEG2000 decoding is performed (S606). When the decoding is completed, the decoded image is subjected to reduced resolution as compared with the original image, but it is visually similar to the original image.

According to an embodiment of the present invention, only the important data part of all the data constituting the image is transmitted. Thereby, it is possible to reduce the traffic on the network as well as lower the price of the service. In particular, the effects caused by traffic reduction are increased on a wireless network where a bandwidth is restricted.

While the invention has been shown and described with reference to certain embodiments thereof, it will be understood by those skilled in the art that various changes in form and details may be made therein without departing from the spirit and scope of the invention as defined by the appended claims.

What is claimed is:

1. An apparatus for transmitting an image, comprising:
an encoder for encoding image data by decomposing the image data according to a frequency component of the image data;
a fragmenter for selecting a part of the encoded image data based on a fragmentation position calculated using PSNR value; and
a transmitter for transmitting the selected part of the image data and information on a size of the encoded image.

2. The apparatus of claim 1, wherein the part of the encoded image data is selected to include the lowest frequency component of the encoded image data.

3. The apparatus of claim 1, wherein the image data is encoded by use of wavelet transform.

4. The apparatus of claim 3, wherein the wavelet transform is performed using at least one of JPEG2000 (Joint Photographers Experts Group 2000) and SPIHT (Set Partitioning In Hierarchical Trees).

5. The apparatus of claim 1, wherein the fragmenter receives the image data intended for transmission and information on desired image quality from the user, determines a value of PSNR (Peak Signal to Noise Ratio) corresponding to the received desired image quality information, compares the PSNR value with a fragment reference value preset to act as a standard for permitting fragmentation, calculates a fragmentation position according to the PSNR value from the encoded image data when the PSNR value exceeds the fragment reference value, and fragments the encoded image data on the basis of the calculated fragmentation position.

6. The apparatus of claim 5, wherein the fragment reference value is set within a range such that when image restoration is performed at a reception terminal a restored image is visually similar to the original image.

7. The apparatus of claim 6, wherein the fragment reference value is set to 30 dB.

8. An apparatus for receiving an image, comprising:
a receiver for receiving fragmented image data and information on an image size from a transmission terminal;
a defragmenter for adding NULL data to the received fragmented image data and then generating new image data having a size identical to the received image size; and
a decoder for decoding the new image data generated by the defragmenter.

9. The apparatus of claim 8, wherein the decoding is performed by use of wavelet inverse transform.

10. The apparatus of claim 9, wherein the wavelet inverse transform is performed using at least one of JPEG2000 (Joint Photographers Experts Group 2000) and SPIHT (Set Partitioning In Hierarchical Trees).

11. A method for transmitting an image, comprising the steps of:
encoding image data by decomposing the image data according to a frequency component of the image data;
selecting a part of the encoded image data based on a fragmentation position calculated using PSNR value and fragmenting the encoded image data according to the selected part of the encoded image data; and
transmitting the fragmented image data and information on a size of the encoded image.

12. The method of claim 11, wherein the part of the encoded image data is selected to include the lowest frequency component of the encoded image.

13. The method of claim 11, wherein the image data is encoded by use of wavelet transform.

14. The method of claim 13, wherein the wavelet transform is performed using at least one of JPEG2000 (Joint Photographers Experts Group 2000) and SPIHT (Set Partitioning In Hierarchical Trees).

15. The method of claim 11, wherein the step of selecting and fragmenting comprises: receiving the image intended for transmission and information on a desired image quality from a user, finding a value of a PSNR (Peak Signal to Noise Ratio) corresponding to the received desired image quality information, comparing the PSNR value with a fragment reference value preset to act as a standard of permitting fragmentation, calculating a fragmentation position according to the PSNR value from the encoded image data when the PSNR value exceeds the fragment reference value, and fragmenting the encoded image data on the basis of the calculated fragmentation position.

16. The method of claim 15, wherein the fragment reference value is set within a range such that when image restoration is performed at a reception terminal a restored image is visually similar to the encoded image.

17. The method of claim 16, wherein the fragment reference value is set to 30 dB.

18. A method for receiving an image, comprising the steps of:
receiving fragmented image data and information on an image size from a transmission terminal;
adding NULL data to the received fragmented image data and then generating new image data having a size identical to the received image size; and
decoding the generated new image data.

19. The method of claim 18, wherein the decoding is performed by use of wavelet inverse transform.

20. The method of claim 19, wherein the wavelet inverse transform is performed using at least one of JPEG2000 (Joint Photographers Experts Group 2000) and SPIHT (Set Partitioning In Hierarchical Trees).
